(19) United States
(12) Patent Application Publication
(10) Pub. No.: US 2026/0045896 A1
(43) Pub. Date: Feb. 12, 2026

(54) AC MOTOR CONTROL DEVICE, ELECTRIC VEHICLE, AND AC MOTOR CONTROL METHOD

(71) Applicant: Hitachi Astemo, Ltd., Hitachinaka-shi, Ibaraki (JP)

(72) Inventors: Shun TANIGUCHI, Tokyo (JP); Kentaro MATSUO, Hitachinaka-shi (JP); Toshiyuki AJIMA, Tokyo (JP)

(73) Assignee: Hitachi Astemo, Ltd., Hitachinaka-shi, Ibaraki (JP)

(21) Appl. No.: 18/992,820

(22) PCT Filed: Jun. 2, 2023
(86) PCT No.: PCT/JP2023/020647

§ 371 Date: Jan. 9, 2025

(30) Foreign Application Priority Data
Sep. 8, 2022 (JP) 2022-142700

(51) Int. Cl. H02P 23/14; H02P 23/04

(52) U.S. Cl. CPC H02P 23/14; H02P 23/04

(57) ABSTRACT

Provided is an AC motor control device that controls driving of an AC motor by voltage phase control, the AC motor control device being capable of increasing a response speed as a whole while suppressing a reverse response of a current. The AC motor control device converts DC power into AC power based on a voltage phase command output from a voltage phase control unit and outputs the AC power to an AC motor, and the voltage phase control unit includes a change amount limiting unit that limits a change amount of a voltage phase.

### TECHNICAL FIELD

The present invention relates to a configuration of an AC motor control device that drives and controls an AC motor and a control method thereof, and particularly relates to a technique effective for application to an AC motor for an electric automobile that is required to achieve both high responsiveness and vibration suppression.

### BACKGROUND ART

A drive system of an electric automobile such as an electric vehicle (EV) is required to have a reduced weight, a reduced size, a reduced cost, and a reduced noise and a reduced vibration. In particular, there is a problem that the vibration and energy loss of a motor become significant at the time of high-speed rotation, and various techniques for suppressing the vibration of the motor at the time of the high-speed rotation are being developed.

On the other hand, in control (rectangular wave drive or the like) of an AC motor by a voltage phase control, application of pulse saving control (for example, one pulse control) has been examined in order to improve a voltage utilization rate in a high-speed range.

As the related art of the present technical field, for example, there is a technique such as PTL 1. PTL 1 proposes voltage phase control for controlling a voltage phase angle such that torque coincides with a command value in order to realize a voltage close to an output voltage limit of an inverter. In this control, a limiter is applied to the voltage phase angle in order to prevent an occurrence of a situation in which the control has failed by the voltage phase angle reaching outside the predetermined range.

In addition, PTL 2 proposes control for suppressing an occurrence of a situation in which a d-axis current value deviates from a normal control range, by performing smoothing processing for calculation of a torque estimation value.

### CITATION LIST

### Patent Literature

PTL 1: JP 3746377 B
PTL 2: JP 2010-183661 A

### SUMMARY OF INVENTION

### Technical Problem

In the voltage phase control of the AC motor to which the above-described pulse saving control (for example, one pulse control) is applied, in a case where the response is made fast, there is a case where the response is too fast and the current reversely responds. Since this reverse response may lead to generation of vibration of the AC motor, it is necessary to limit the response as a whole so as not to make the reverse response.

However, when the response is limited as a whole, the response becomes too slow.

FIG. 1 illustrates an example of a reverse response of a current in voltage phase control. FIG. 1 illustrates a response of an actual current value 63 to an input of a current command value 61.

In the voltage phase control, when the response is made faster, there is a case where characteristics of a reverse response in which a current follows a command value after responding in a direction opposite to a change of the command value, as illustrated in FIG. 1, are exhibited.

Even though the voltage phase angle is limited by the voltage phase control in PTL 1, it is not possible to suppress such a reverse response.

Further, in PTL 2, it is possible to suppress a reverse response when the d-axis current reversely responds, but a case where a q-axis current reversely responds is not assumed. The reverse response occurs, and particularly causes a problem in a case where the reverse response occurs at the time of the maximum current and the overcurrent occurs, and a case where the d-axis current reversely responds and then flows in a normal range from a negative direction to a positive direction. PTL 2 is a countermeasure against the latter, and does not act on the former.

As described above, in the related art, a case where the q-axis current reversely responds and becomes an overcurrent is not assumed.

Therefore, an object of the present invention is to provide an AC motor control device and a control method of an AC motor capable of increasing a response speed as a whole while suppressing a reverse response of a current, in the AC motor control device that drives and controls an AC motor by voltage phase control.

### Solution to Problem

In order to solve the above problems, according to the present invention, an AC motor control device converts DC power into AC power based on a voltage phase command output from a voltage phase control unit and outputs the AC power to an AC motor, and the voltage phase control unit includes a change amount limiting unit that limits a change amount of a voltage phase.

In addition, according to the present invention, a control method of an AC motor that controls driving of the AC motor includes limiting a change amount of a voltage phase command output from a voltage phase control unit.

### Advantageous Effects of Invention

According to the present invention, in an AC motor control device that drives and controls an AC motor by voltage phase control, it is possible to realize an AC motor control device and a control method of an AC motor capable of increasing a response speed as a whole while suppressing a reverse response of a current.

As a result, it is possible to contribute to vibration suppression and ride comfort improvement in a high-speed range of an electric automobile such as an EV.

Objects, configurations, and advantageous effects other than those described above will be clarified by the descriptions of the following exemplary embodiments.

### BRIEF DESCRIPTION OF DRAWINGS

FIG. 1 is a diagram conceptually illustrating an example of a reverse response of a current in voltage phase control.

FIG. 2 is a block diagram illustrating an overall configuration of an AC motor control device according to Embodiment 1 of the present invention.

FIG. 3 is a block diagram illustrating an example of a rectangular wave generation unit 15 in FIG. 2.

FIG. 4 is a block diagram illustrating an example of a voltage phase control unit 13 in FIG. 2.

FIG. 5 is a diagram conceptually illustrating an operation trajectory of the current according to a constant term.

FIG. 6 is a diagram illustrating an example of a situation in which the reverse response of the current occurs at time of forward rotation.

FIG. 7 is a diagram illustrating an example of a situation in which the reverse response of the current occurs at time of reverse rotation.

FIG. 8 is a block diagram illustrating an overall configuration of an AC motor control device according to Embodiment 2 of the present invention.

FIG. 9 is a block diagram illustrating an example of a voltage phase control unit 13B in FIG. 8.

FIG. 10 is a diagram illustrating an example of an input-output relationship correspondence table of a limit value calculation unit 49 in FIG. 9.

FIG. 11 is a diagram illustrating a modification example of the input-output relationship correspondence table of the limit value calculation unit 49.

FIG. 12 is a diagram illustrating another modification example of the input-output relationship correspondence table of the limit value calculation unit 49.

FIG. 13 is a diagram illustrating still another modification example of the input-output relationship correspondence table of the limit value calculation unit 49.

FIG. 14 is a diagram illustrating a schematic configuration of an electric automobile according to Example 3 of the present invention.

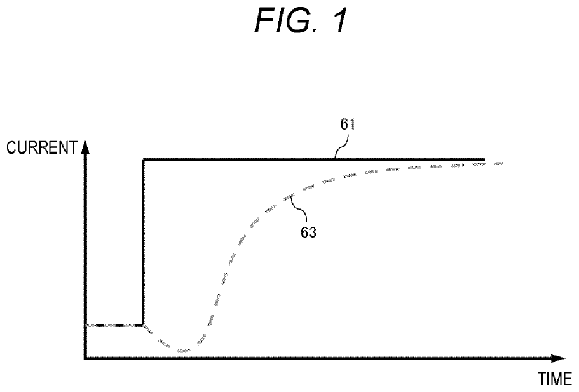

### DESCRIPTION OF EMBODIMENTS

Hereinafter, embodiments of the present invention will be described with reference to the drawings. In the drawings, the same components are denoted by the same reference signs, and the detailed description of the repetitive parts will be omitted.

In addition, in the following description, a permanent magnet synchronous motor (PMSM) is used as a target, but the present invention is not limited to the permanent magnet synchronous motor, and a synchronous machine such as a synchronous reluctance motor, a permanent magnet synchronous generator, or a winding-type synchronous machine can obtain similar effects.

In addition, a semiconductor switching element of an inverter device is assumed to be an insulated gate bipolar transistor (IGBT), but the present invention is not limited thereto, and a metal oxide semiconductor field effect transistor (MOSFET) or other power semiconductor elements may be provided.

### Embodiment 1

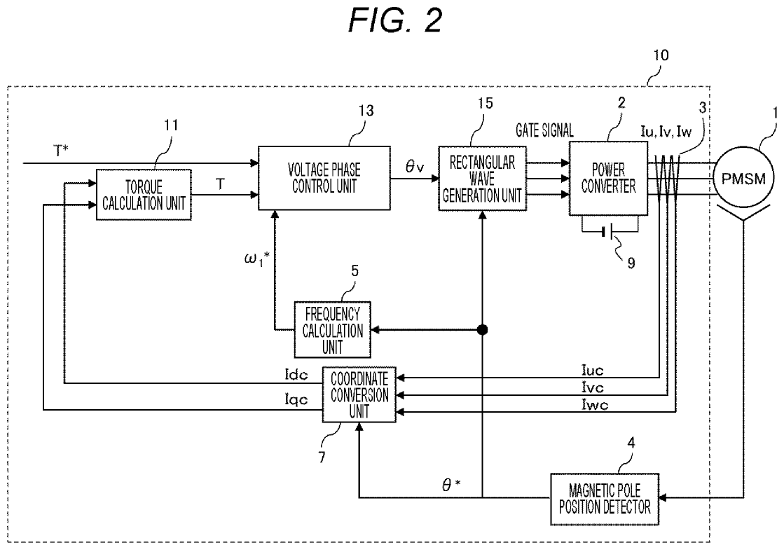

An AC motor control device according to Embodiment 1 of the present invention will be described with reference to FIGS. 2 to 7.

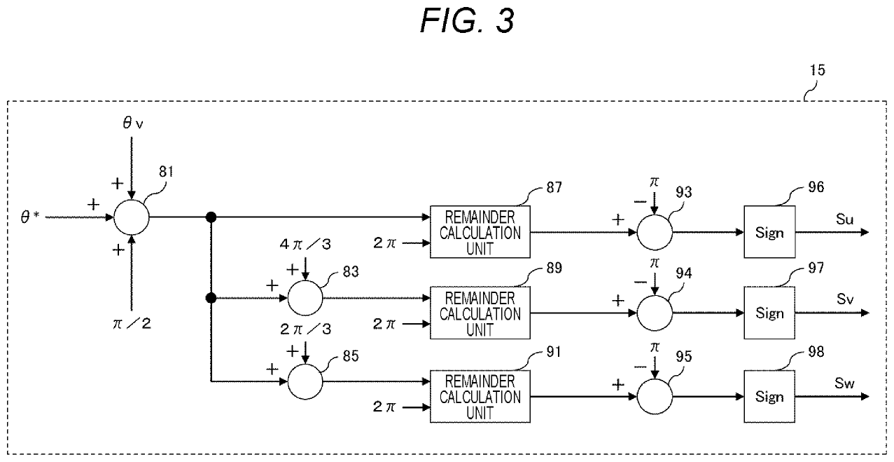

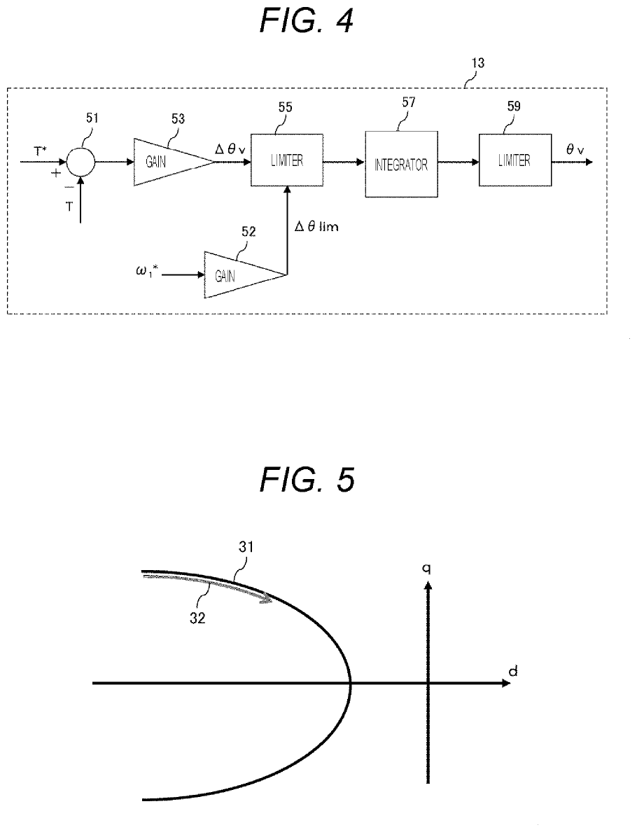

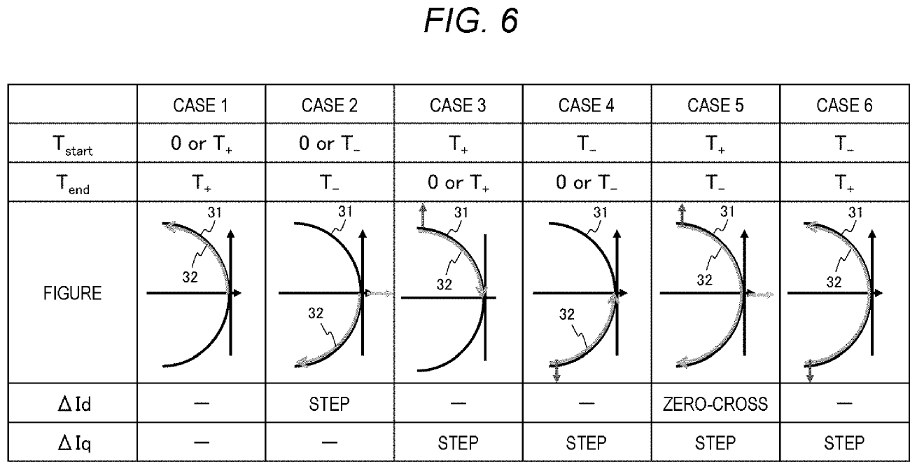

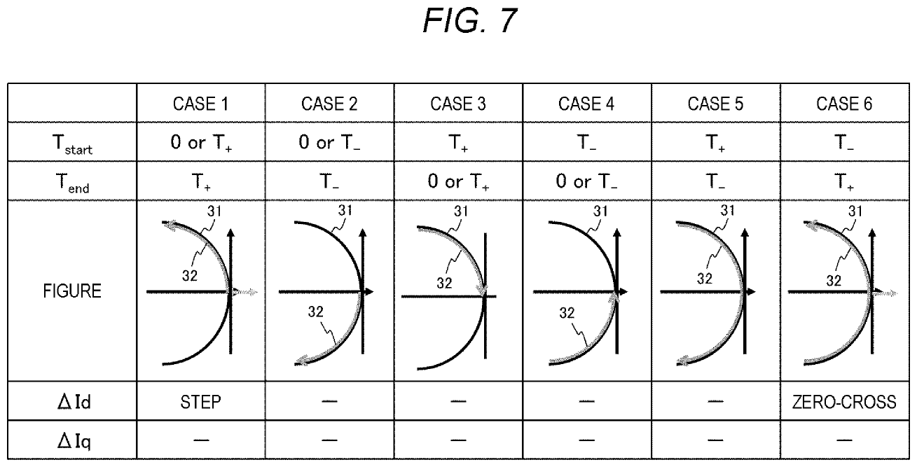

FIG. 2 is a block diagram illustrating an overall configuration of an AC motor control device 10 in the present embodiment. FIG. 3 is a block diagram illustrating an example of a rectangular wave generation unit 15 in FIG. 2. FIG. 4 is a block diagram illustrating an example of a voltage phase control unit 13 in FIG. 2. FIG. 5 is a diagram conceptually illustrating an operation trajectory of a current according to a constant term. FIG. 6 is a diagram illustrating an example of a situation in which a reverse response of a current occurs at the time of forward rotation, and FIG. 7 is a diagram illustrating an example of a situation in which the reverse response of the current occurs at the time of reverse rotation.

As illustrated in FIG. 2, the AC motor control device 10 in the present embodiment includes, as main components, a power converter 2, phase current detection means 3, a magnetic pole position detector 4, a frequency calculation unit 5, a coordinate transformation unit 7, a torque calculation unit 11, a voltage phase control unit 13, and a rectangular wave generation unit 15.

The power converter 2 converts DC power from a DC voltage source 9 (for example, a battery) into AC power in accordance with a gate signal (for example, a rectangular wave pulse signal) which will be described later, and drives a permanent magnet synchronous motor (PMSM) 1.

The phase current detection means 3 includes a Hall current transformer (CT) or the like, and detects current waveforms Iuc, Ivc, and Iwc of three phases of a U-phase, a V-phase, and a W-phase flowing from the power converter 2 to the PMSM 1.

The magnetic pole position detector 4 includes a resolver or the like, detects the magnetic pole position of the PMSM 1, and outputs magnetic pole position information θ*.

The frequency calculation unit 5 outputs speed information ω1* from the magnetic pole position information θ* detected by the magnetic pole position detector 4, for example, by differential calculation.

The coordinate transformation unit 7 coordinate-transforms Iuc, Ivc, and Iwc detected by the phase current detection means 3 with the magnetic pole position information θ* detected by the magnetic pole position detector 4, and outputs dq-axis current detection values Idc and Iqc.

The torque calculation unit 11 calculates torque T by using the dq-axis current detection values Idc and Iqc. The torque calculation unit 11 performs calculation by using, for example, Expression (1).

$$\begin{matrix}[ Math . 1 ] & \\ T = N ( ( {L}_{d} - {L}_{q} ) {I}_{dc} + {ϕ}_{m} ) {I}_{qc} & ( 1 )\end{matrix}$$

Here, Ld and Lq represent a dq-axis inductance, om represents a magnet magnetic flux coefficient, and N represents a pole logarithm.

Note that the calculation may be performed by using a lookup table instead of a mathematical expression.

The voltage phase control unit 13 outputs a voltage phase angle θv such that the torque T coincides with a torque command value T*. Since the present function is a function serving as a point of the invention, details thereof will be described later.

For example, as illustrated in FIG. 3, in the rectangular wave generation unit 15, an adder 81 adds the voltage phase angle θv and π/2 to the magnetic pole position information θ* to generate a voltage phase signal, and a remainder calculation unit 87 calculates a remainder divided by 2π. Then, a subtractor 93 further subtracts π, and a sign determiner 96 determines a (positive or negative) sign of an output of the subtractor 93, and a pulse signal Su is calculated according to the sign.

Similarly, adders 83 and 85 respectively add 4π/3 and 2π/3 to a voltage phase signal, and remainder calculation units 89 and 91 respectively calculate the remainder divided by 2π. Then, subtractors 94 and 95 further subtract π, sign determiners 97 and 98 determine the (positive and negative) signs of the outputs of the subtractors 94 and 95, and pulse signals Sv and Sw are calculated according to the signs. A gate signal is generated and output from the pulse signals Su, Sv, and Sw in consideration of the dead time.

First, details of the voltage phase control unit 13 as a point of the present invention will be described below.

FIG. 4 illustrates an example of the voltage phase control unit 13.

The subtractor 51 calculates a difference between the torque command value T* and the torque T, multiplies the difference by a gain 53 in consideration of a response, and outputs a change amount Δθv of the voltage phase angle to a limiter 55. On the other hand, a limit value Δθlim obtained by multiplying the speed information ω1* calculated by the frequency calculation unit 5 by the gain 52 is output to the limiter 55.

The limiter 55 limits the output such that the change amount Δθv of the voltage phase angle falls within a range of ±Δθlim.

An integrator 57 integrates the change amount Δθv of the voltage phase angle limited by the limiter 55 and outputs the integrated value to a limiter 59.

The limiter 59 limits an output voltage phase angle θv not to fall within an unstable region.

Next, the principle of voltage phase control by the voltage phase control unit 13 will be described.

The responses of dq-axis voltages δv_{d} and δv_{q} to a voltage phase operation amount δθᵥ are expressed by Expression (2).

$$\begin{matrix}[ Math . 2 ] & \\ [ \begin{matrix}δ {v}_{d} \\ δ {v}_{q}\end{matrix} ] = [ \begin{matrix}{v}_{q 0} \\ - {v}_{d 0}\end{matrix} ] δ {θ}_{v} & ( 2 )\end{matrix}$$

The responses of dq-axis currents δi_{d} and δi_{q} to the dq-axis voltages δv_{d} and δv_{q} are expressed by Expression (3).

$$\begin{matrix}[ Math . 3 ] & \\ [ \begin{matrix}δ {i}_{d} \\ δ {i}_{q}\end{matrix} ] = \frac{1}{( R + {L}_{d} s ) ( R + {L}_{q} s ) + {L}_{d} {L}_{q} {ω}_{1}^{2}} [ \begin{matrix}R + {L}_{q} s & {L}_{q} {ω}_{1} \\ - {L}_{d} {ω}_{1} & R + {L}_{d} s\end{matrix} ] [ \begin{matrix}δ {v}_{d} \\ δ {v}_{q}\end{matrix} ] & ( 3 )\end{matrix}$$

From Expressions (2) and (3), the responses of the dq-axis currents δi_{d} and δi_{q} to the voltage phase operation amount δθᵥ are expressed by Expression (4). However, resistance R is ignored from R<<Lqω1.

$$\begin{matrix}[ Math . 4 ] & \\ [ \begin{matrix}δ {i}_{d} \\ δ {i}_{q}\end{matrix} ] = \frac{1}{{L}_{d} {L}_{q}} \frac{1}{{L}_{d} {L}_{q} + R \frac{{L}_{d} + {L}_{q}}{{L}_{d} {L}_{q}} s + {ω}_{1}^{2}} [ \begin{matrix}{V}_{q 0} {sL}_{q} - {V}_{d 0} {ω}_{1} {L}_{q} \\ - {V}_{d 0} {sL}_{d} - {V}_{q 0} ω {L}_{d}\end{matrix} ] δ {θ}_{v} & ( 4 )\end{matrix}$$

In Expression (4), a current 32 moves along a constant voltage ellipse 31 as illustrated in FIG. 5 by the stationary term illustrated in Expression (5) with s=0, and moves out of the constant voltage ellipse 31 by the transient term illustrated in Expression (6).

$$\begin{matrix}[ Math . 5 ] & \\ [ \begin{matrix}δ {i}_{d} \\ δ {i}_{q}\end{matrix} ] = \frac{1}{{L}_{d} {L}_{q}} \frac{1}{{ω}_{1}^{3}} [ \begin{matrix}- {V}_{d 0} {ω}_{1} {L}_{q} \\ - {V}_{q 0} ω {L}_{d}\end{matrix} ] {δθ}_{v} & ( 5 )\end{matrix}$$

$$\begin{matrix}[ Math . 6 ] & \\ [ \begin{matrix}δ {i}_{d} \\ δ {i}_{q}\end{matrix} ] = \frac{1}{{L}_{d} {L}_{q}} \frac{1}{{s}^{2} + R \frac{{L}_{d} + {L}_{q}}{{L}_{d} {L}_{q}} s + {ω}_{1}^{2}} [ \begin{matrix}{V}_{q 0} {sL}_{q} \\ - {V}_{d 0} {sL}_{d}\end{matrix} ] δ {θ}_{v} & ( 6 )\end{matrix}$$

Here, when the current is substituted into a voltage by focusing on the transient term acting in a direction deviating from the assumed operation, Expression (7) is obtained.

$$\begin{matrix}[ Math . 7 ] & \\ [ \begin{matrix}δ {i}_{d} \\ δ {i}_{q}\end{matrix} ] = \frac{1}{\frac{{s}^{2}}{{ω}_{1}^{2}} + \frac{R}{{ω}_{1}^{2}} \frac{{L}_{d} + {L}_{q}}{{L}_{d} {L}_{q}} s + 1} [ \begin{matrix}\frac{1}{{ω}_{1}} ( {I}_{d 0} + \frac{{ϕ}_{m}}{{L}_{d}} ) \\ \frac{1}{{ω}_{1}} {I}_{q 0}\end{matrix} ] s δ {θ}_{v} & ( 7 )\end{matrix}$$

Since φm and Ld are positive from the expression of Id, the d-axis current reversely responds in the positive direction in the vicinity of Id=0 when Δθv (=s×θv) is positive in the forward rotation (ω1>0), that is, when the rotation is performed in a direction in which the torque decreases. When Id increases in the negative direction, Id0+φm/Ld decreases. Thus, the effect that the d-axis current acts in the direction deviating from the constant voltage ellipse 31 by the change amount Δθv (=s×θv) of the voltage phase angle is reduced.

On the other hand, with the expression of Iq, when Δθv (=s×θv) is positive in the forward rotation (ω1>0), that is, when the rotation is performed in the direction in which the torque decreases, Iq acts in the direction in which Iq increases. In this case, when Iq is positive, this may lead to an occurrence of an overcurrent. On the other hand, when Δθv (=s×θv) is negative in the forward rotation (ω1>0), that is, when the rotation is performed in the direction in which the torque increases, Iq acts in the direction in which Iq decreases. In this case, when Iq is negative, this may lead to an occurrence of an overcurrent.

The above description is summarized as in FIG. 6. FIG. 6 is a diagram illustrating an example of a situation in which the reverse response of the current occurs at time of forward rotation. In the drawing, “step” represents a time when the torque command changes (particularly, when the torque command changes stepwise), and “zero-cross” represents a time when the torque passes through 0. As illustrated in FIG. 6, a total of six patterns are conceivable as a situation in which a large reverse response occurs.

FIG. 7 illustrates a result of similar examination in reverse rotation (ω1<0). Regarding Iq, ΔIq is generated in a torque change direction, so that the reverse response is not obtained. Regarding Id, the reverse response may occur when the rotation is performed in the direction in which the torque increases (when Δθv is negative), contrary to the case of the forward rotation.

Here, it is understood that the change amount Δθv of the voltage phase angle may be limited in order to suppress the reverse response. In addition, since the amount of the reverse response is inversely proportional to the speed ω1, the limit value Δθlim of the change amount Δθv of the voltage phase angle may be determined in proportion to the speed ω1.

Furthermore, the gain to be multiplied by the gain 52 is determined based on Expression (7). When the change amount limit value of the d-axis current is set as ΔId_lim, the limit value Δθlim of the change amount Δθv of the voltage phase angle at Id=0 is expressed by Expression (8).

$$\begin{matrix}[ Math . 8 ] & \\ Δ {θ}_{lim} = {ω}_{1} \frac{{L}_{d}}{{ϕ}_{m}} Δ {I}_{d \_ lim} & ( 8 )\end{matrix}$$

On the other hand, when the change amount limit value of the q-axis current is set as ΔIq_lim, the limit value Δθlim of the change amount Δθv of the voltage phase angle is represented by Expression (9).

$$\begin{matrix}[ Math . 9 ] & \\ Δ {θ}_{lim} = {ω}_{1} \frac{Δ {I}_{q \_ lim}}{{I}_{q 0}} & ( 9 )\end{matrix}$$

Iq0 may use current Iq or may be calculated from the q-axis current at the time of the maximum torque. Alternatively, a value in which a filter considering the response is applied to the q-axis current command value may be used.

When the smaller value of the above Expressions (8) and (9) is used as the gain used for calculating Δθlim, the value can be suppressed within the change amount limit values ΔId_lim and ΔIq_lim assuming the reverse response.

As described above, the AC motor control device 10 in the present embodiment converts DC power into AC power based on the voltage phase command output from the voltage phase control unit 13 and outputs the AC power to the PMSM 1, and the voltage phase control unit 13 includes the change amount limiting unit that limits the change amount of the voltage phase command.

Then, the change amount limiting unit performs control such that the change amount of the voltage phase command falls within a predetermined range.

In addition, the change amount limiting unit changes the limit amount of the change amount of the voltage phase command in proportion to the rotational speed ω1 of the PMSM 1.

In addition, the change amount limiting unit determines whether or not to limit the change amount of the voltage phase command based on the current command value or the current detection value detected via the phase current detection means 3, and changes the limit amount of the change amount.

In addition, the change amount limiting unit determines whether or not to limit the change amount of the voltage phase command based on the rotation direction of the PMSM 1 and changes the limit amount of the change amount.

Note that the gain multiplied by the gain 52 may be adjusted based on the step response by an actual machine test or simulation instead of being determined from the mathematical expression.

In addition, in the present embodiment, the limit value Δθlim of the change amount Δθv of the voltage phase angle is set such that the d-axis current does not reach the positive region due to the reverse response and the q-axis current does not become overcurrent due to the reverse response, but it is also possible to use the limit value Δθlim to suppress one of the events.

Further, in the present embodiment, the example of a method of operating the voltage phase angle θv such that the torque T and the torque command value T* coincide with each other has been described. However, the present invention can be applied to any method of operating the voltage phase angle θv, such as a method of operating the voltage phase angle θv such that the q-axis current and the q-axis current command value coincide with each other or a method of operating the voltage phase angle θv such that the d-axis current and the d-axis current command value coincide with each other.

In addition, in the present embodiment, an example of one-pulse control has been described as the pulse saving control, but the present invention can be applied as long as a torque control method of operating the voltage phase angle θv is adopted even in the case of three-pulse control or the like.

### Embodiment 2

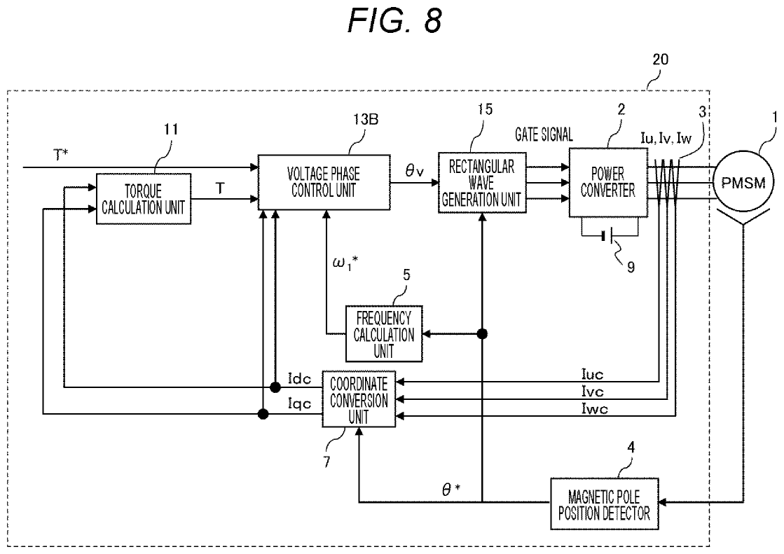

An AC motor control device according to Embodiment 2 of the present invention will be described with reference to FIGS. 8 to 13.

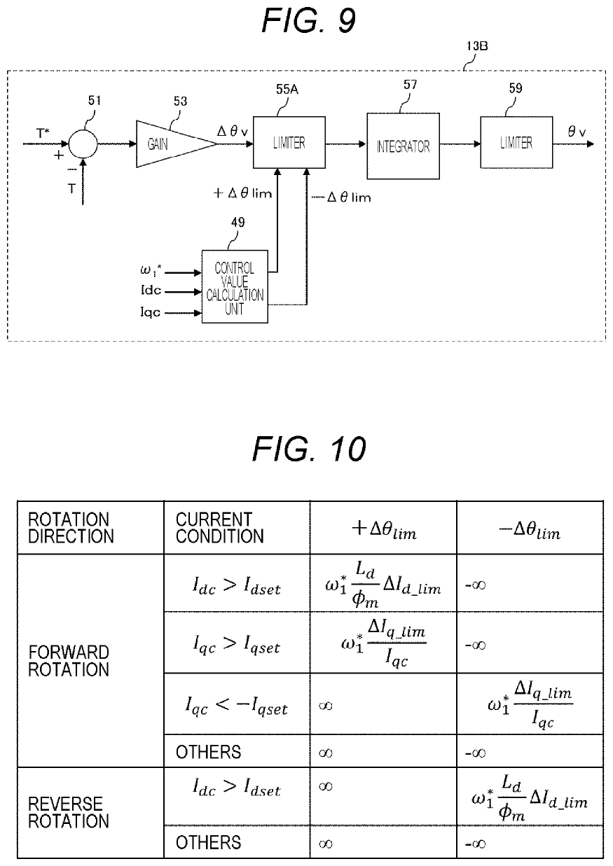

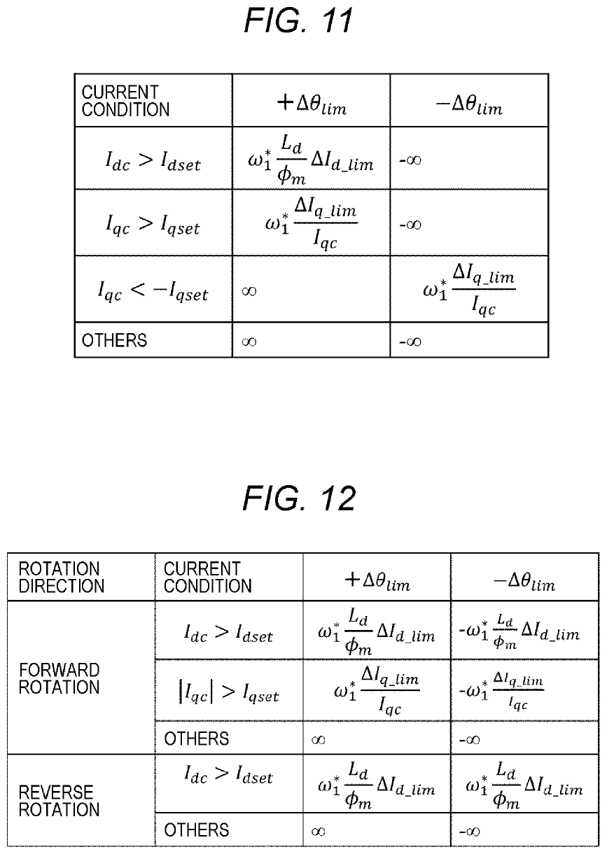

FIG. 8 is a block diagram illustrating an overall configuration of an AC motor control device 20 in the present embodiment. FIG. 9 is a block diagram illustrating an example of a voltage phase control unit 13B in FIG. 8. FIG. 10 is a diagram illustrating an example of an input-output relationship correspondence table of a limit value calculation unit 49 in FIG. 9. FIGS. 11 to 13 are diagrams illustrating modification examples of the input-output relationship correspondence table of the limit value calculation unit 49.

In the present embodiment, a difference in configuration from Embodiment 1 will be mainly described.

As illustrated in FIG. 8, the AC motor control device 20 in the present embodiment is different from the AC motor control device 10 in Embodiment 1 (FIG. 2) in that the dq-axis current detection values Idc and Iqc from the coordinate transformation unit 7 are added as inputs to the voltage phase control unit 13B. FIG. 9 illustrates details of the voltage phase control unit 13B.

The limit value calculation unit 49 calculates a voltage phase change amount limit +Δθlim in the positive direction and a voltage phase change amount limit −Δθlim in the negative direction from the dq-axis current detection values Idc and Iqc and the speed information ω1* in accordance with a condition table of FIG. 10.

FIG. 10 illustrates a voltage phase change amount limit value that can suppress the reverse response in accordance with the rotation direction and the current condition based on FIGS. 6 and 7 and Expressions (8) and (9).

For example, Idset is set to 0, and when the value is larger than Idset, the voltage phase change amount limits +Δθlim and −Δθlim are set to suppress the reverse response of the d-axis current Idc to the positive region.

In addition, for example, 90% of the maximum value of the q-axis current Iqc is set as Iqset, and when the value is larger than Iqset, the voltage phase change amount limits +Δθlim and −Δθlim are set to suppress the reverse response and the overcurrent.

As a result, by limiting the change amount Δθv of the voltage phase angle only when the reverse response occurs, it is possible to increase the speed of the response by eliminating the limit on the change amount Δθv of the voltage phase angle in the other region while suppressing the reverse response.

Note that, in the present embodiment, the condition is changed by the forward rotation and the reverse rotation. However, in the case of a motor that basically uses only the forward rotation, in order to simplify software, for example, the voltage phase change amount limits +Δθlim and −Δθlim may be calculated in accordance with the condition table as illustrated in FIG. 11, and the determination may be made only by the forward rotation while ignoring the condition of the reverse rotation.

In addition, in FIG. 10, the voltage phase change amount limits +Δθlim and −Δθlim are changed in the positive direction and the negative direction. In order to simplify the software, for example, the voltage phase change amount limits +Δθlim and −Δθlim may be calculated in accordance with the condition table as illustrated in FIG. 12, and the stricter voltage phase change amount limit value may be set in both the positive and negative directions as a limit condition.

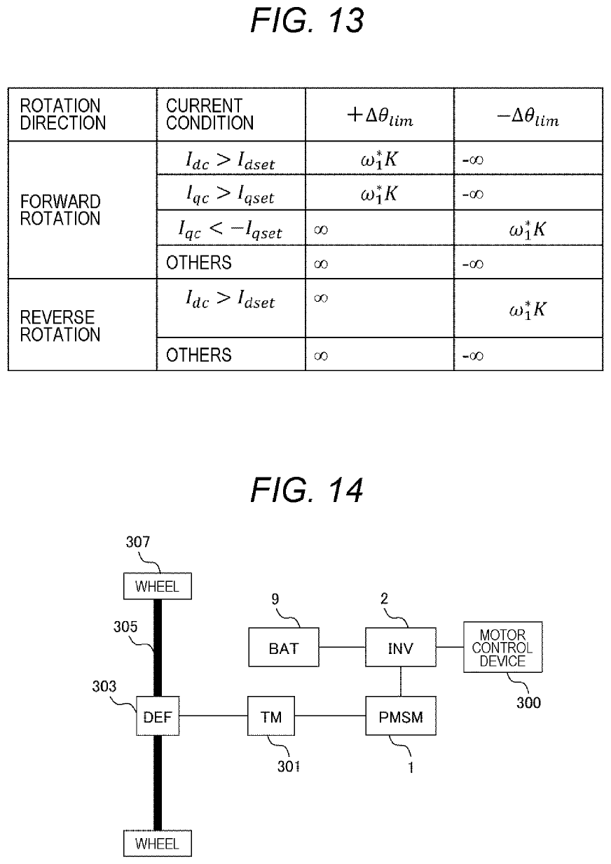

Alternatively, in Expressions (8) and (9), Expression (10) represents the ratio of the change amount limit value ΔId_lim to the d-axis current required to weaken the magnet magnetic flux, and Expression (11) represents the ratio of the change amount limit value ΔIq_lim to the current current. Thus, for example, the voltage phase change amount limits +Δθlim and −Δθlim may be calculated in accordance with the condition table as illustrated in FIG. 13, and the constant K may be set to, for example, 10% (0.1) or the like.

$$\begin{matrix}[ Math . 10 ] & \\ \frac{{L}_{d}}{{ϕ}_{m}} Δ {I}_{d \_ lim} & ( 10 )\end{matrix}$$

$$\begin{matrix}[ Math . 11 ] & \\ \frac{Δ {I}_{q \_ lim}}{{I}_{qc}} & ( 11 )\end{matrix}$$

Note that, in the present embodiment, the dq-axis currents Idc and Iqc are used, but a value considering a delay in current control may be used as the dq-axis current command value.

In addition, in the present embodiment, the q-axis current Iqc is used for the determination. Instead of using the q-axis current Iqc for the determination, the determination may be made for t seconds after the step response of the change amount ΔT* of the torque command value is applied to the torque command value T*.

Alternatively, it may be determined that t seconds have elapsed since the step response of the q-axis current command value Iq* has been received instead of the torque command value T*.

In addition, the determination may be made such that the q-axis current Iqc changes in the direction of the step response by the change amount ΔIq after the step response is applied.

In addition, in the present embodiment, the current is used to determine the situation in which the reverse response occurs, but the magnetic flux proportional to the current may be used instead of the current.

As described above, under a determination condition that can represent the situation in which the reverse response of the current occurs as illustrated in FIGS. 6 and 7 described in Embodiment 1, even by using any method, it is determined that the reverse response may occur, and the limit is set to the change amount Δθv of the voltage phase angle, whereby it is possible to release the limit of the change amount Δθv of the voltage phase angle and increase the speed of the response while suppressing the reverse response, in other cases except for the situation in which the reverse response may occur.

Note that, in the present embodiment, the example of a method of operating the voltage phase angle θv such that the torque T and the torque command value T* coincide with each other has been described. However, the present invention can be applied to any method of operating the voltage phase angle θv, such as a method of operating the voltage phase angle θv such that the q-axis current and the q-axis current command value coincide with each other or a method of operating the voltage phase angle θv such that the d-axis current and the d-axis current command value coincide with each other.

In addition, in the present embodiment, an example of one-pulse control has been described as the pulse saving control, but the present invention can be applied as long as a torque control method of operating the voltage phase angle θv is adopted even in the case of three-pulse control or the like.

### Embodiment 3

An electric automobile according to Example 3 of the present invention will be described with reference to FIG. 14.

FIG. 14 is a diagram illustrating a schematic configuration of an electric automobile according to the present embodiment. In the electric automobile in the present embodiment, the AC motor control device described in Embodiments 1 and 2 is used as a motor control device 300.

As described in Embodiments 1 and 2, the motor control device 300 controls power supplied from the power converter (inverter) 2 to the permanent magnet synchronous motor (PMSM) 1.

The DC voltage source (for example, a battery) 9 supplies power to the inverter 2.

The PMSM 1 is connected to a transmission 301.

The transmission 301 is connected to a drive shaft 305 via a differential gear 303 and supplies power to a wheel 307. Note that a configuration of directly being connected to the differential gear 303 without the transmission 301 or a configuration in which the PMSM 1 and the inverter 2 are applied to the front wheel and the rear wheel, respectively, may be adopted.

In a motor for an automobile, a high-speed response of torque is required for vibration suppression or idling control. Thus, a high-speed response in voltage phase control is required as compared with other applications. In addition, since tolerance for overcurrent is small for size reduction, it is necessary to suppress the reverse response.

Therefore, it can be said that this is an application in which the effects of the present invention significantly appear. Similarly, since a railway vehicle is the same moving object as an automobile and idling control is required, the railway vehicle is also an application in which the effects of the present invention are easily exhibited similarly. By applying the present invention, the reverse response can be suppressed in an automobile and a railway vehicle, so that the response can be improved as a whole. This leads to improvement in ride comfort of a driver or a passenger.

The present invention is not limited to the above embodiments, and various modification examples may be provided. For example, the above embodiments are described in detail in order to explain the present invention in an easy-to-understand manner, and the above embodiments are not necessarily limited to a case including all the described configurations. Further, some components in one embodiment can be replaced with the components in another embodiment, and the configuration of another embodiment can be added to the configuration of one embodiment. Regarding some components in the embodiments, other components can be added, deleted, and replaced.

### REFERENCE SIGNS LIST

1 permanent magnet synchronous motor (PMSM)
2 power converter (inverter)
3 phase current detection means
4 magnetic pole position detector
5 frequency calculation unit
7 coordinate transformation unit
9 DC voltage source (battery)
10, 20 AC motor control device
11 torque calculation unit
13, 13B voltage phase control unit
15 rectangular wave generation unit
31 constant voltage ellipse
32 current
49 limit value calculation unit
51, 93, 94, 95 subtractor
52, 53 gain
55, 55A, 59 limiter
57 integrator
61 current command value
63 actual current value
81, 83, 85 adder
87, 89, 91 remainder calculation unit
96, 97, 98 sign determiner
300 motor control device
301 transmission
303 differential gear
305 drive shaft
307 wheel

1. An AC motor control device that converts DC power into AC power based on a voltage phase command output from a voltage phase control unit and outputs the AC power to an AC motor,
wherein the voltage phase control unit includes a change amount limiting unit that limits a change amount of a voltage phase.

2. The AC motor control device according to claim 1, wherein the change amount limiting unit performs control such that the change amount of the voltage phase falls within a predetermined range.

3. The AC motor control device according to claim 1, wherein the change amount limiting unit changes a limit amount of the change amount of the voltage phase in proportion to a rotational speed of the AC motor.

4. The AC motor control device according to claim 1, further comprising:
current detection means for detecting a current of the AC motor,
wherein the change amount limiting unit determines whether or not to limit the change amount of the voltage phase based on a current command value or a current detection value detected via the current detection means, and changes the limit amount of the change amount.

5. The AC motor control device according to claim 4, wherein the change amount limiting unit determines whether or not to limit the change amount of the voltage phase based on a rotation direction of the AC motor, and changes the limit amount of the change amount.

6. The AC motor control device according to claim 1, further comprising:
a power converter that converts DC power into AC power based on the voltage phase command output from the voltage phase control unit,
wherein the power converter uses a rectangular wave pulse.

7. An electric automobile comprising:
the AC motor control device according to claim 1.

8. A control method of an AC motor that controls driving of the AC motor, the control method comprising:
limiting a change amount of a voltage phase command output from a voltage phase control unit.

9. The control method of an AC motor according to claim 8, wherein control is performed such that the change amount of the voltage phase command falls within a predetermined range.

10. The control method of an AC motor according to claim 8, wherein a limit amount of the change amount of the voltage phase command is changed in proportion to a rotational speed of the AC motor.

11. The control method of an AC motor according to claim 8, wherein it is determined whether or not the change amount of the voltage phase command is limited based on a current command value or a current detection value of the AC motor, and a limit amount of the change amount is changed.

12. The control method of an AC motor according to claim 11, wherein it is determined whether or not the change amount of the voltage phase command is limited based on a rotation direction of the AC motor, and the limit amount of the change amount is changed.

13. The control method of an AC motor according to claim 8, wherein DC power is converted into AC power by using a rectangular wave pulse and the AC power is supplied to the AC motor.
